(19) United States
(12) Patent Application Publication
(10) Pub. No.: US 2023/0050676 A1
(43) Pub. Date: Feb. 16, 2023

(54) AGRICULTURAL SYSTEM AND ASSEMBLY FOR ADJUSTABLY SUPPORTING A DRAWBAR OF AN AGRICULTURAL VEHICLE

(71) Applicant: CNH Industrial America LLC, New Holland, PA (US)

(72) Inventors: John Rasset, Barnesville, MN (US); Timothy Hertsgaard, Fargo, ND (US)

(21) Appl. No.: 17/858,607

(22) Filed: Jul. 6, 2022

Related U.S. Application Data
(60) Provisional application No. 63/233,433, filed on Aug. 16, 2021.

(51) Int. Cl. A01B 59/042

(52) U.S. Cl. CPC A01B 59/042

(57) ABSTRACT

A drawbar support assembly for adjustably supporting a drawbar of an agricultural vehicle includes a support member fixable relative to a frame of the agricultural vehicle. The support member has first and second support flanges laterally spaced apart, each flange defining flange holes longitudinally spaced apart from each other. The support assembly further includes a drawbar hanger having a bar support portion and a saddle portion. The bar support portion extends between first and second lateral ends and defines a first bar support hole proximate the first lateral end and a second bar support hole proximate the second lateral end. The saddle portion is fixed to the bar support portion such that an opening is formed for receiving the drawbar. The drawbar hanger is selectively positionable relative to the support flanges along the longitudinal direction such that the bar support holes are aligned with respective ones of the flange holes.

### CROSS-REFERENCE TO RELATED APPLICATIONS

The present disclosure is based upon and claims the right of priority to U.S. Provisional Patent Application No. 63/233,433 filed on Aug. 16, 2021, the entirety of which is incorporated by reference herein for all purposes.

### FIELD OF THE INVENTION

The present disclosure relates generally to work vehicles and, more particularly, to agricultural systems and assemblies for adjustably supporting a drawbar of an agricultural work vehicle, such as a tractor, for towing an implement.

### BACKGROUND OF THE INVENTION

Agricultural work vehicles, such as tractors, harvesters, etc., are commonly used to perform a variety of agricultural tasks (e.g., to tow planters or seeders for planting seeds, to tow spraying implements for applying fertilizer, to tow tillage implements for tillage operations, for harvesting agricultural product, etc.). Typically, towed implements are attached to the work vehicle by a hitch or drawbar assembly at the rear end of the work vehicle. Different configurations of implements results in significant variations in weight distribution and clearance with rear wheels or tracks of the work vehicle. As such, different implement configurations may require different towing distances from the rear axle of the work vehicle, but many drawbar assemblies only allow for one towing distance from the rear axle.

Accordingly, an agricultural system and assembly for adjustably supporting a drawbar of an agricultural vehicle would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for adjustably supporting a drawbar of an agricultural vehicle. The agricultural system includes a rear frame of the agricultural vehicle, and a support member fixed relative to the rear frame. The support member has a first support flange and a second support flange spaced apart from each other in a lateral direction, where each of the first and second support flanges extends between a first longitudinal end and a second longitudinal end along a longitudinal direction of the agricultural vehicle and defines flange holes spaced apart from each other along the longitudinal direction. The agricultural system further includes a drawbar hanger comprising a bar support portion and a saddle portion. The bar support portion extends between a first lateral end and a second lateral end along the lateral direction. The bar support portion defines a first bar support hole positioned proximate the first lateral end and a second bar support hole positioned proximate the second lateral end, where the first bar support hole is spaced apart from the second bar support hole in the lateral direction. The saddle portion is fixed to the bar support portion such that an opening is formed along the longitudinal direction between the saddle portion and the bar support portion. Additionally, the agricultural system includes a drawbar extending between a proximal end and a distal end along the longitudinal direction, where the proximal end is receivable in the opening formed between the saddle portion and the bar support portion, and the distal end is couplable to the rear frame. The drawbar hanger is selectively positionable relative to the first and second support flanges along the longitudinal direction such that the first and second bar support holes are aligned with respective ones of the flange holes of the first and second support flanges.

In another aspect, the present subject matter is directed to a drawbar support assembly for adjustably supporting a drawbar of an agricultural vehicle. The drawbar support assembly includes a support member fixable relative to a rear frame of the agricultural vehicle. The support member has a first support flange and a second support flange spaced apart from each other in a lateral direction, where each of the first and second support flanges extends between a first longitudinal end and a second longitudinal end along a longitudinal direction of the agricultural vehicle and defines flange holes spaced apart from each other along the longitudinal direction. The drawbar support assembly further includes a drawbar hanger comprising a bar support portion and a saddle portion. The bar support portion extends between a first lateral end and a second lateral end along the lateral direction. The bar support portion defines a first bar support hole positioned proximate the first lateral end and a second bar support hole positioned proximate the second lateral end, the first bar support hole being spaced apart from the second bar support hole in the lateral direction. The saddle portion is fixed to the bar support portion such that an opening along the longitudinal direction is formed between the saddle portion and the bar support portion for receiving a drawbar of the agricultural vehicle. Additionally, the drawbar support assembly includes at least one first coupling element insertable through the first bar support hole and one of the flange holes of the first support flange, and at least one second coupling element insertable through the second bar support hole and one of the flange holes of the second support flange. The drawbar hanger is selectively positionable relative to the first and second support flanges along the longitudinal direction such that the first and second bar support holes are aligned with respective ones of the flange holes of the first and second support flanges.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a perspective view of an assembly for adjustably supporting a drawbar of an agricultural work vehicle in accordance with aspects of the present subject matter, particularly illustrating the assembly in a closest support position for the drawbar;

FIG. 3 illustrates another perspective view of the assembly for adjustably supporting the drawbar of the agricultural work vehicle shown in FIG. 2 in accordance with aspects of the present subject matter, particularly illustrating the assembly in an intermediate support position for the drawbar;

FIG. 4 illustrates an additional perspective view of the assembly for adjustably supporting the drawbar of the agricultural work vehicle shown in FIG. 2 in accordance with aspects of the present subject matter, particularly illustrating the assembly in a rearmost support position for the drawbar;

FIG. 5 illustrates a perspective view of one embodiment of a drawbar of an agricultural work vehicle in accordance with aspects of the present subject matter;

FIGS. 6 and 7 illustrate other perspective views of the assembly for adjustably supporting a drawbar of the agricultural work vehicle shown in FIGS. 2-4 in accordance with aspects of the present subject matter, particularly illustrating one embodiment of the drawbar having adjustable stop assemblies;

FIG. 8 illustrates a partial, perspective view of another embodiment of a hanger suitable for use with the assembly for adjustably supporting the drawbar of the agricultural work vehicle shown in FIGS. 2-4 and the drawbar shown in FIG. 5 in accordance with aspects of the present subject matter, particularly illustrating the hanger having adjustable stop assemblies;

FIG. 9 illustrates a section view of the assembly for adjustably supporting the drawbar of the agricultural work vehicle shown in FIGS. 2-4 having the hanger shown in FIG. 8 in accordance with aspects of the present subject matter, particularly illustrating the hanger being oriented for an intermediate or rearmost support position; and

FIG. 10 illustrates another section view of the assembly for adjustably supporting the drawbar of the agricultural work vehicle shown in FIGS. 2-4 having the hanger shown in FIG. 8 in accordance with aspects of the present subject matter, particularly illustrating the hanger being oriented for a closest support position.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to agricultural systems and assemblies for adjustably supporting a drawbar of an agricultural work vehicle, such as a tractor. Particularly, a drawbar support assembly may be positioned at a rear end of the work vehicle, where the drawbar support assembly includes a support member fixed relative to a rear frame of the work vehicle and a drawbar hanger that is movably supported relative to the support member. More particularly, the support member includes left and right support flanges that are spaced apart in a lateral direction and define a plurality of holes spaced apart along the front-rear direction of the work vehicle. The drawbar hanger includes a bar support portion extending laterally across the left and right support flanges, and a saddle portion fixed to the bar support portion such that an opening for receiving a drawbar of the work vehicle is formed along the front-rear direction of the work vehicle between the bar support and saddle portions. The bar support portion defines one or more holes proximate a left end and one or more holes proximate the right end. The holes of the bar support portion may align with different pairs of the holes across the left and right support flanges such that the opening for receiving the drawbar is adjustably positioned at different distances relative to the rear frame of the work vehicle in the front-rear direction.

Additionally, the drawbar and/or the drawbar hanger may have one or more features that allow the drawbar and the drawbar hanger to be in contact along the front-rear direction of the work vehicle. As such, if the drawbar hanger hits the ground during travel, the force applied to the drawbar hanger by the ground, that typically would cause torque of the drawbar hanger, is instead transferred to the drawbar to prevent damage to the drawbar hanger. Similarly, if an implement uncouples from the drawbar, the force applied to the drawbar hanger by a safety chain coupled between the drawbar hanger and the implement, that typically would cause torque of the drawbar hanger, is instead transferred to the drawbar to prevent damage to the drawbar hanger.

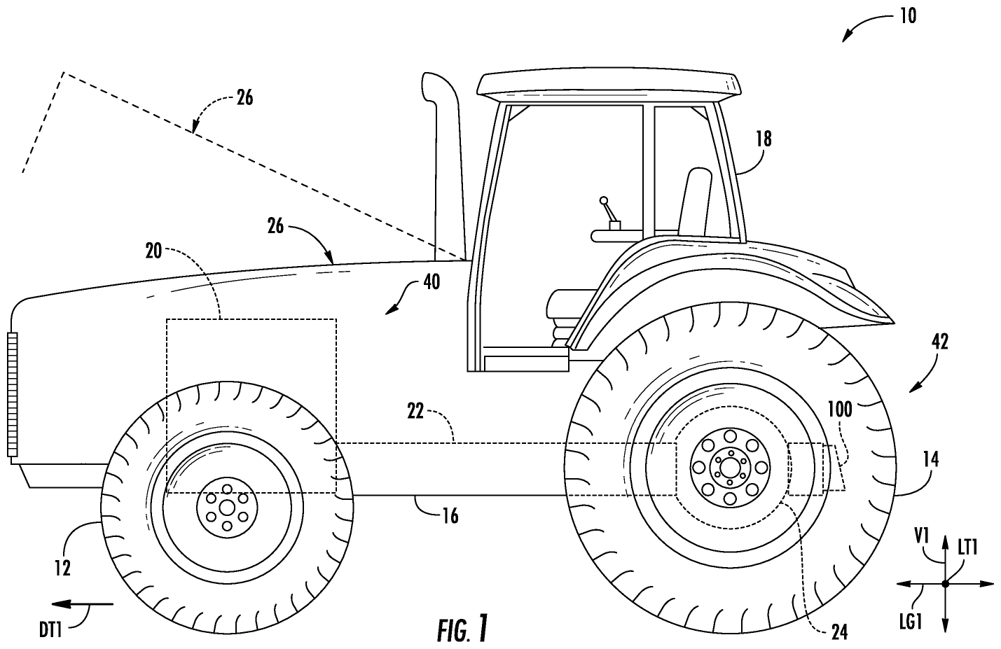

Referring now to the drawings, FIG. 1 illustrates one embodiment of a work vehicle 10 in accordance with aspects of the present subject matter. In particular, FIG. 1 illustrates a side view of the work vehicle 10. It should be appreciated that, although the work vehicle 10 illustrated herein is configured as an agricultural tractor, the work vehicle 10 may generally be configured as any suitable work vehicle known in the art, such as various other agricultural vehicles, earth-moving vehicles, road vehicles, loaders and/or the like.

As shown in FIG. 1, the work vehicle 10 includes a pair of front wheels 12, a pair or rear wheels 14, and a chassis or frame 16 coupled to and supported by the wheels 12, 14. An operator's cab 18 may be supported by a portion of the frame 16 and may house various control devices (not shown) for permitting an operator to control the operation of the work vehicle 10. Additionally, the work vehicle 10 may include an engine 20 and a transmission 22 mounted on the frame 16. The transmission 22 may be operably coupled to the engine 20 and may provide variably adjusted gear ratios for transferring engine power to the wheels 12, 14 via a differential 24. In some embodiments, the work vehicle 10 is configured as a four-wheel drive vehicle, where the front and rear wheels 12, 14 are all driven by the engine 20 and transmission 22. However, in other embodiments, the work vehicle 10 is configured as a two-wheel drive, where only the front wheels 12 or only the rear wheels 14 are driven by the engine 20 and transmission 22.

The work vehicle 10 may also include a hood 26 configured to least partially surround and/or cover the various under-hood components stored within the vehicle's engine compartment 40, such as the engine 20 and any other suitable under-hood components (e.g., hydraulic components, pneumatic components, electrical components, mechanical component(s), storage tank(s), etc.). As particularly shown in FIG. 1, the hood 26 may be configured to be pivotally coupled to a portion of the work vehicle 10 at or adjacent to its aft or rear end such that the hood 26 can be pivoted about the aft end between a closed position (shown in solid lines in FIG. 1) and an opened position (shown in dashed lines in FIG. 1).

As will be described below in greater detail, the work vehicle 10 may be configured to tow an implement. As such, the work vehicle 10 additionally includes a hitch or drawbar assembly 100 at the aft or rear end 42 of the work vehicle relative to a forward direction of travel DT1, the drawbar assembly 100 being supported by the frame 16 (e.g., near a rear axle of the rear wheels 14).

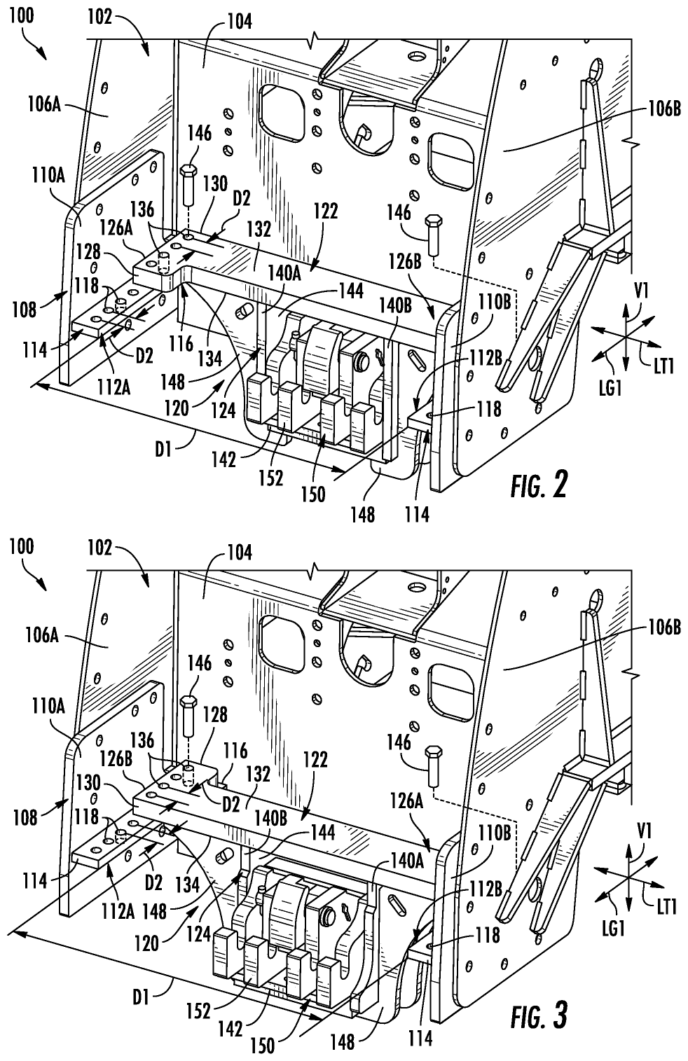

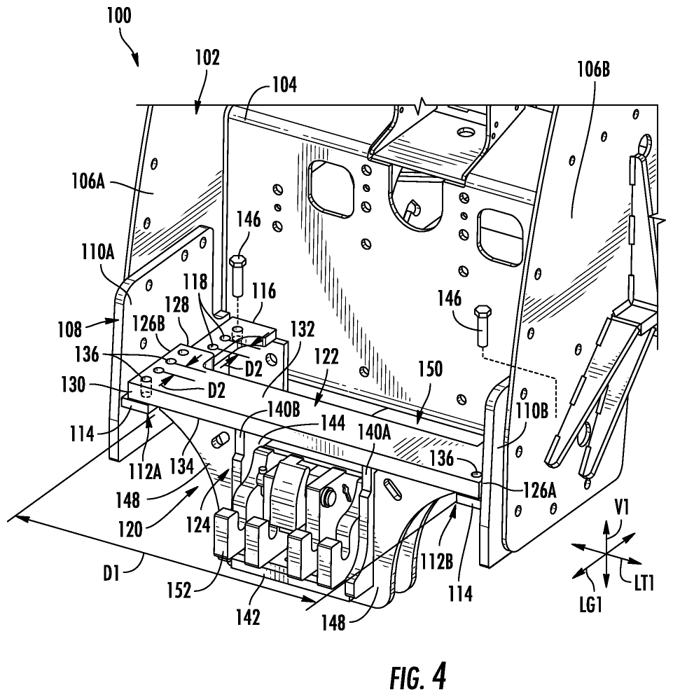

Referring now to FIGS. 2-4, various views of an assembly (i.e., drawbar support assembly 100) for adjustably supporting a drawbar of an agricultural work vehicle are illustrated in accordance with aspects of the present subject matter. Particularly, FIG. 2 illustrates the assembly 100 in a closest support position for the drawbar, FIG. 3 illustrates the assembly 100 in an intermediate support position for the drawbar, and FIG. 4 illustrates the assembly 100 in a rearmost support position for the drawbar.

As shown in FIGS. 2-4, the drawbar support assembly 100 includes a rear plate 102, a support member 108, and a drawbar hanger 120. The rear plate 102 is mounted to the frame 16 (FIG. 1) proximate the rear end 42 (FIG. 1) of the work vehicle 10 (FIG. 1). The rear plate 102 includes a first wall 104 extending substantially along a lateral direction LT1, and two side walls 106, including a first or left sidewall 106A and a second or right sidewall 106B, extending rearwardly from the first wall 104 along a front-rear or longitudinal direction LG1 and perpendicular to the first wall 104. The support member 108 is fixed to the rear plate 102. For instance, the support member 108 includes a first or left support wall 110A and a second or right support wall 110B extending along the longitudinal direction LG1. The left support wall 110A is fixed to the left sidewall 106A of the rear plate 102 and the right support wall 110B is fixed to the right sidewall 106B of the rear plate 102. The left and right support walls 110A, 110B each include a support flange extending laterally outwardly therefrom. For example, the left support wall 110A has a left support flange 112A and the right support wall 110B has a right support flange 112B. The support flanges 112A, 112B extend in a horizontal plane defined by the longitudinal and lateral directions LG1, LT1. More particularly, the support flanges 112A, 112B extend along the longitudinal direction LG1 between a first longitudinal end 114 and a second longitudinal end 116 and are spaced apart from each other in the lateral direction LT1 by a first distance D1. Each of the support flanges 112A, 112B defines a plurality of flange holes 118 extending at least partially through the flanges 112A, 112B. In one embodiment, an axis of each of the flange holes 118 extends along a vertical direction V1. In one embodiment, the flange holes 118 are evenly spaced apart from each other along the longitudinal direction by a hole spacing distance D2. However, in some embodiments, the flange holes 118 may be spaced apart from each other by varying distances. It should be appreciated that while the right flange 112B is not shown in its entirety, the right flange 112B is a mirror image of the left flange 112A, such that pairs of the flange holes 118 between the left and right flanges 112A, 112B are aligned along the lateral direction LT1.

The drawbar hanger 120 includes a bar support portion 122 and a saddle portion 124. The bar support portion 122 has a lateral width defined between a first or left lateral end 126A and a second or right lateral end 126B along the lateral direction LT1, a length defined along the longitudinal direction LG1 between a first bar longitudinal end 128 and a second bar longitudinal end 130, and a thickness defined between an upper side 132 and a lower side 134 along the vertical direction V1. The bar support portion 122 defines a plurality of bar support holes 136 extending therethrough. In one embodiment, an axis of each the bar support holes 136 extends along the vertical direction V1. At least one of the holes 136 is positioned proximate the left lateral end 126A and at least of the holes 136 is positioned proximate the right lateral end 128B (FIG. 4). The holes 136 positioned proximate the left lateral end 126A are spaced apart from each other along the longitudinal direction LG1 by the spacing distance D2. Similarly, the holes 136 positioned proximate the right lateral end 126B are spaced apart from each other along the longitudinal direction LG1 by the same, spacing distance D2. It should be appreciated that while the bar support portion 122 is not shown in its entirety, bar support portion 122 is symmetric about the longitudinal direction LG1 such that the bar support holes 136 proximate the left and right lateral ends 126A, 126B are aligned along the lateral direction LT1.

The saddle portion 124 is fixable or fixed to the bar support portion 122 between the first and second lateral ends 126A, 126B of the bar support portion 122. For instance, in one embodiment, the saddle portion 124 is fixable or fixed to the lower side 134 of the bar support portion 122. Alternatively, in another embodiment, the saddle portion 124 is fixable or fixed to the upper side 132 of the bar support portion 122. However, it should be appreciated that the saddle portion 124 may be otherwise fixable or fixed to the bar support portion 122. More particularly, the saddle portion 124 is formed by a first saddle wall 140A, a second saddle wall 140B, and a third saddle wall 142 such that the saddle portion 124 has a u-shaped cross-section when viewed along the longitudinal direction LG1. For instance, the first and second saddle walls 140A, 140B extend along the longitudinal direction LG1 and are spaced apart in the lateral direction LT1 by the third saddle wall 142 extending along the lateral direction LT1, the third saddle wall 142 being coupled to a vertical end of the first and second saddle walls 140A, 140B along the vertical direction V1. The saddle portion 124 is fixable or fixed to the bar support portion 122 such that an open side of the u-shaped cross-section, opposite the third saddle wall 142, is closest to the bar support portion 122. As such, an opening 144 is created between the bar support portion 122 and the saddle portion 124 where the opening 144 is configured to receive a drawbar 150 of the work vehicle 10 (FIG. 1), as will be described in greater detail below.

The drawbar hanger 120 is configured to be supported relative to the rear plate 102, and thus the frame 16 (FIG. 1) of the work vehicle 10, by the support member 108. Particularly, the drawbar hanger 120 is selectively positionable relative to the first and second support flanges 112A, 112B along the longitudinal direction LG1 such that the bar support holes 136 are aligned with respective ones of the flange holes 118 of the first and second support flanges 112A, 112B. For instance, the lateral width of the bar support portion 122 is generally larger than the first distance D1. More particularly, the left lateral end 126A of the bar support portion 122 at least partially overlaps the left support flange 112A such that the bar support hole(s) 136 positioned proximate the left lateral end 126A of the bar support portion 122 may align with one or more of the flange holes 118 of the left support flange 112A. Similarly, the right lateral end 126B of the bar support portion 122 at least partially overlaps the right support flange 112B such that the bar support hole(s) 136 positioned proximate the right lateral end 126B of the bar support portion 122 may align with one or more of the flange holes 118 of the right support flange 112B.

It should be appreciated that while the size and the shape of the flange holes 118 are shown as being the same as the size and the shape of the bar support holes 136, the size and/or the shape of the flange holes 118 may be different from the size and/or the shape of the bar support holes 136.

The drawbar hanger 120 is selectively positionable relative to the left and right support flanges 112A, 112B at a plurality of positions. For instance, the drawbar hanger 120 is selectively movable relative to the left and right support flanges 112A, 112B in the longitudinal direction LG1 between a first longitudinal position along the longitudinal direction LG1 (FIGS. 2 and 3) and a second longitudinal position along the longitudinal direction LG1 (FIG. 4), the second longitudinal position being further than the first longitudinal position from the first wall 104 of the rear plate 102, and thus, further from the rear end of the frame 16 (FIG. 1) of the work vehicle 10 (FIG. 1). The bar support holes 136 of the bar support portion 122 are aligned with at least a first pair of the flange holes 118 of the left and right support flanges 112A, 112B when the drawbar hanger 120 is disposed at the first longitudinal position (FIGS. 2 and 3) and the bar support holes 136 are aligned with at least one separate, second pair of the flange holes 118 of the left and right support flanges 112A, 112B when the drawbar hanger 120 is disposed at the second longitudinal position (FIG. 4). For instance, the bar support holes 136 are aligned with four, first pairs of the flange holes 118 of the left and right support flanges 112A, 112B when in the first longitudinal position (FIGS. 2 and 3) and four, second pairs of the flange holes 118 of the left and right support flanges 112A, 112B when in the second longitudinal position (FIG. 4), the four, first pairs of the flange holes 118 being separate from the four, second pairs of flange holes 118.

In some embodiments, the saddle portion 124 of the drawbar hanger 120 is positioned closer to the second longitudinal end 130 of the bar support portion 122. As such, the drawbar hanger 120 may be rotated in addition to, or instead of, being translated along the longitudinal direction to change the longitudinal position of the saddle portion 124 relative to the frame 16 (FIG. 1). For example, in FIGS. 2 and 3, the drawbar hanger 120 is aligned with a same set or first pairs of the flange holes 118 of the left and right support flanges 112A, 112B, but the drawbar hanger 120 is in a first rotational position in FIG. 2 such that the second bar longitudinal end 130 of the bar support portion 122 is positioned closer to the first wall 104 than the first bar longitudinal end 128 of the bar support portion 122 and is rotated to a second rotational position in FIG. 3 such that the first bar longitudinal end 128 of the bar support portion 122 is positioned closer to the first wall 104 than the second bar longitudinal end 130 of the bar support portion 122.

It should be appreciated that while each of the left and right support flanges 112A, 112B is illustrated as defining eight flange holes 118, each of the left and right support flanges 112A, 112B may have any other suitable number of flange holes such as two to six flange holes 118 or nine or greater flange holes 118. Similarly, while the bar support portion 122 is shown as having four bar support holes 136 at each of the left and right lateral ends 126A, 126B, it should be appreciated that the bar support portion 122 may have any other suitable number of bar support holes 136 at each of the left and right lateral ends 126A, 126B, such as one, two, three, five, or more bar support holes 136. Generally, each of the left and right support flanges 112A, 112B has more flange holes 118 than bar support holes 136 at each of the left and right lateral ends 126A, 126B of the bar support portion 122 such that the bar support portion 122 may be positioned at multiple longitudinal positions relative to the support member 108. It should also be appreciated that, while only three longitudinal positions of the drawbar hanger 120 are shown, the drawbar hanger 120 may have any suitable number of positions relative to the support member 108.

Moreover, in some embodiments, the drawbar support assembly 100 includes coupling elements 146 for selectively fixing the drawbar hanger 120 to the support member 108. For instance, a first one(s) of the coupling elements 146 may be inserted through the bar support hole(s) 136 positioned proximate the left lateral end 126A of the bar support portion 122 aligned with the flange hole(s) 118 of the left support flange 112A, and second one(s) of the coupling elements 146 may be inserted through the bar support hole(s) 136 proximate the right lateral end 126B of the bar support portion 122 aligned with the flange hole(s) 118 of the right support flange 112B. It should be appreciated that the coupling elements 146 may include any suitable coupling elements or combination of coupling elements, including, but not limited to, bolts, screws, locking pins, and/or the like.

Additionally, in some embodiments, the drawbar support assembly 100 includes one or more gusset members 148 configured to help support the left and right sidewalls 106A, 106B of the rear plate 102 and the left and right support walls 110A, 110B of the support member 108. More particularly, the gusset member(s) 148 may extend between a respective one of the first or second saddle wall 140A, 140B and the bar support portion 122, and generally parallel to the lateral direction LT1 between the respective one of the first or second saddle wall 140A, 140B and the respective left or right support wall 110A, 110B of the support member 108. In one embodiment, the gusset member(s) 148 may be contoured to receive or wrap around at least a portion of the saddle portion 124. For instance, the gusset member(s) 148 may at least partially wrap around the first saddle wall 140A and the third saddle wall 142 and/or may at least partially wrap around the second saddle wall 140B and the third saddle wall 142.

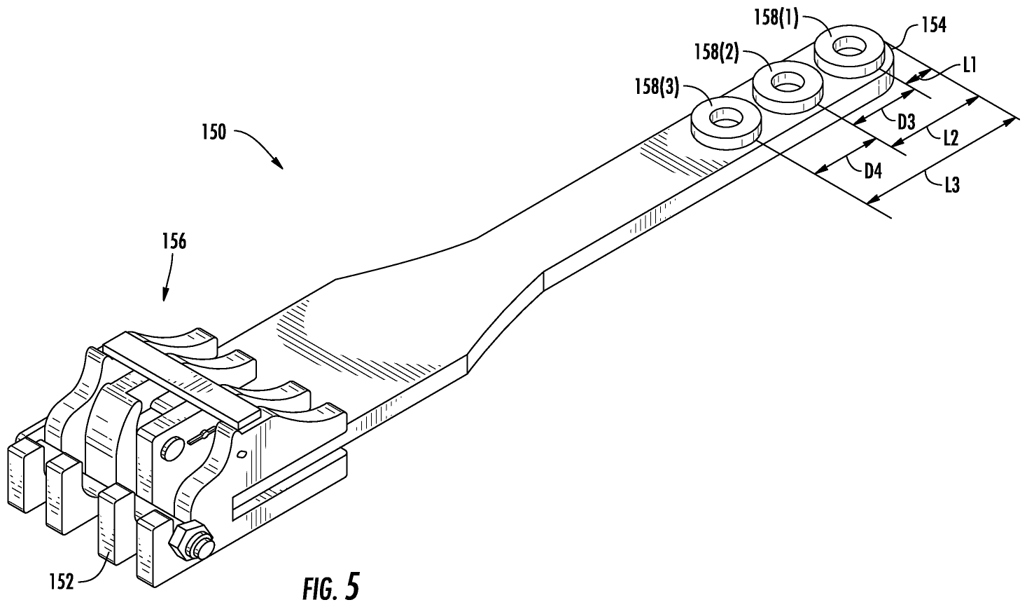

Referring now to FIG. 5, a perspective view of one embodiment of the drawbar 150 of an agricultural work vehicle, such as the work vehicle 10, suitable for use with the assembly 100 shown in FIGS. 2-4 is illustrated in accordance with aspects of the present subject matter. The drawbar 150 extends along a length defined between a proximal end 152 and a distal end 154. The drawbar 150 includes an implement coupling structure 156 at the proximal end, where the implement coupling structure 156 is receivable within the opening 144 of the drawbar hanger 120 (FIGS. 2-4) and is configured to couple an implement to the work vehicle 10 (FIG. 1). The drawbar 150 defines one or more drawbar coupling openings 158 proximate the distal end 154. The drawbar 150 is adjustably couplable to the frame 16 (FIG. 1) of the work vehicle 10 (FIG. 1) by each of the drawbar coupling openings 158. For instance, the drawbar coupling openings 158 may be spaced apart along the length of the drawbar 150 such that each of the openings 158 is associated with a different one of the longitudinal positions of the drawbar hanger 120 (FIGS. 2-4). For example, a first drawbar coupling opening 158(1) may be spaced apart from the distal end 154 by a first length L1, a second drawbar coupling opening 158(2) may be spaced apart from the distal end 154 by a second length L2, and a third drawbar coupling opening 158(3) may be spaced apart from the distal end 154 by a third length L3. The first drawbar coupling opening 158(1) may be associated with the furthest longitudinal position of the saddle portion 124 (FIG. 4), the second drawbar coupling opening 158(2) may be associated with an intermediate longitudinal position of the saddle portion 124 (FIG. 3), and the third drawbar coupling opening 158(3) may be associated with the closest longitudinal position of the saddle portion 124 (FIG. 2). The distance D3 between the first and second drawbar coupling openings 158(1), 158(2) may thus, be the same as the difference in longitudinal distance between the saddle portion 124 and the first wall 104 between the furthest and intermediate longitudinal positions (FIGS. 3 and 4). Similarly, the distance D4 between the second and third drawbar coupling openings 158(2), 158(3) may thus, be the same as the difference in longitudinal distance between the saddle portion 124 and the first wall 104 between the closest and intermediate longitudinal positions (FIGS. 2 and 3).

It should be appreciated that while only three drawbar coupling openings 158 are illustrated in FIG. 5, the drawbar 150 may define any other suitable number of drawbar coupling openings 158, such as one drawbar opening, two drawbar openings, or four or more coupling openings 158. It should further be appreciated that, instead of having multiple, discrete coupling openings 158, the distal end 154 of drawbar 150 may be coupled to the frame 16 in any other suitable manner that still allows the drawbar 150 to be coupled to the frame 16 (FIG. 1) at different positions along its length, corresponding to different longitudinal positions of the drawbar hanger 120.

In some instances, when the work vehicle 10 is traveling in the forward direction of travel DT1, the drawbar hanger 120 may scrape or hit the ground or an implement (not shown) attached to the drawbar 150 may uncouple from the drawbar 150. In such instances, the ground and/or the implement (via a chain (not shown) coupled between the implement and the drawbar hanger 120) may apply a force F1 to the drawbar hanger 120 in a direction generally opposite the direction of travel DT1. The force F1 may create a moment about or torque through the drawbar hanger 120 that tilts the drawbar hanger 120 rearward and upward relative to the forward direction of travel DT1, which may damage the drawbar hanger 120.

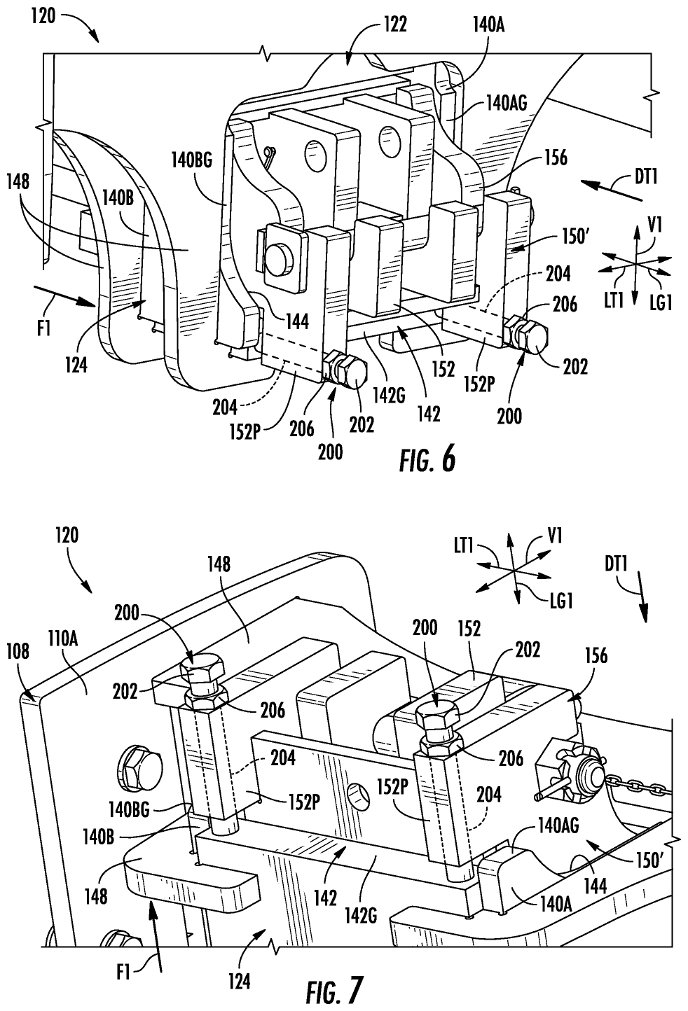

Thus, referring now to FIGS. 6 and 7, other perspective views of the drawbar support assembly 100 for adjustably supporting a drawbar of the agricultural work vehicle 10 are illustrated in accordance with aspects of the present subject matter, particularly illustrating one embodiment of a drawbar 150′ having adjustable stop assemblies. For instance, the drawbar support assembly 100 shown in FIGS. 6 and 7 is substantially the same as shown in FIGS. 2-4, and the drawbar 150′ shown in FIGS. 6 and 7 is substantially the same as the drawbar 150 shown in FIGS. 2-5, except that the drawbar 150′ in FIGS. 6 and 7 additionally includes one or more adjustable stop assemblies 200 configured to contact one of the longitudinal end surfaces of the drawbar hanger 120. The longitudinal end surfaces of the drawbar hanger 120 extend substantially along and parallel to the lateral direction LT1, at least partially along the vertical direction V1, and in some instances perpendicular to the longitudinal direction LG1. Each of the adjustable stop assemblies 200 may include a stop member 202 configured to be received within a respective slot 204 defined in the proximal end 152 of the drawbar 150′. The position of each of the stop members 202 within the respective slot 204 is variable such that the stop member 202 may be brought into contact with one of the longitudinal end surfaces of the drawbar hanger 120 when the drawbar 150′ is received within the hanger 120. For instance, the slot(s) 204 and the stop member(s) 202 may be compatibly threaded, such that the length of the stop member(s) 202 protruding from the slot(s) 204 may be adjusted by rotating the stop member(s) 202. The stop member(s) 202 may be configured as any suitable threaded fastener, such as a bolt, a screw, and/or the like. In some embodiments, each of the adjustable stop assemblies 200 may include a locking fastener 206 between at least a portion of the stop member(s) 202 and the slot(s) 204 to prevent the stop member(s) 202 from rotating due to vibrations during operation of the work vehicle 10. For instance, the locking fastener 206 may be a lock nut, a spring washer, and/or any other suitable fastener or combination of locking fasteners.

In one embodiment, the longitudinal end surface of the drawbar hanger 120 is one of the longitudinal end surfaces 142G (one of which is shown in FIGS. 6 and 7) of the third saddle wall 142 of the saddle portion 124. For example, in some embodiments, such as shown in FIGS. 6 and 7, the slot(s) 204 are defined within one or more extension portions 152P of the proximal end 152 of the drawbar 150′. In one embodiment, the extension portion(s) 152P extend downwardly in the vertical direction V1 relative to the opening 144 and at least partially overlap with the longitudinal end surface 142G of the third saddle wall 142 of the saddle portion 124 in the vertical direction V1 and the lateral direction LT1 when the drawbar 150′ is received within the opening 144. The slot(s) 204 may extend substantially along and parallel to the longitudinal direction LG1 when the drawbar 150′ is received within the hanger 120, such that the stop member(s) 202 is movable perpendicularly relative to the longitudinal end surface 142G of the third saddle wall 142 until it contacts the longitudinal end surface 142G. In one embodiment, as shown, the slot(s) 204 extend through the entire longitudinal thickness of the extension portion(s) 152P in the longitudinal direction LG1. However, in other embodiments, the slot(s) 204 may only extend through part of the longitudinal thickness of the extension portion(s) 152P in the longitudinal direction LG1, with the slot(s) 204 extending into the longitudinal end of the portion(s) 152P closer to the hanger 120. In one embodiment, the extension portion(s) 152P may be integrally formed as part of the implement coupling structure 156 as shown in FIGS. 6 and 7. However, it should be appreciated that, in other embodiments, the extension portion(s) 152P may instead be separately formed and subsequently attached to the implement coupling structure 156.

The drawbar 150′ may have any suitable number of adjustable stop assemblies 200. For instance, in some embodiments, the drawbar 150′ includes two adjustable stop assemblies 200 spaced apart along the lateral direction LT1 so that the stop assemblies 200 do not create a torque force that causes the hanger 120 to additionally twist laterally (e.g., left or right). For example, the adjustable stop assemblies 200 may be at least approximately equidistant from a longitudinal central axis of the drawbar 150′. However, the drawbar 150′ may include any other suitable number of adjustable stop assemblies 200. For instance, the drawbar 150′ may instead include only one stop assembly 200, or three or more stop assemblies 200.

The force F1 applied by the ground when the drawbar hanger 120 hits the ground and/or by an implement through the safety chain when the implement detaches from the drawbar 150′ while the work vehicle 10 is traveling in the forward direction of travel DT1 is transferred from the drawbar hanger 120 to the drawbar 150′ via the adjustable stop assemblies 200. As such, the drawbar hanger 120 is prevented from torque-related damage derived from ground contact or drag forces from the implement. Additionally, because the position of the stop members 202 of the stop assemblies 200 is adjustable, the drawbar hanger 120 and the drawbar 150′ may be in contact, or closer to contact, with each other before a ground impact or implement drag forces regardless of differences in manufacturing or assembly tolerances, which further reduces the potential for damage to the drawbar hanger 120.

It should be appreciated that, while the adjustable stop members 202 are shown as contacting the drawbar hanger 120 while the drawbar hanger 120 is oriented for the intermediate or rearmost position (as in FIG. 3 or 4, respectively), the adjustable stop members 202 could still contact the drawbar hanger 120 if the drawbar hanger 120 was instead oriented for the closest support position (as in FIG. 2). Moreover, it should be appreciated that instead of vertically and laterally overlapping with the longitudinal end surface 142G of the third saddle wall 142, the extension portion(s) 152P may instead, or additionally, at least partially vertically and laterally overlap with a longitudinal end surface 140AG of the first saddle wall 140A and/or a longitudinal end surface 140BG of the second saddle wall 140B in the vertical direction V1 and the lateral direction LT1.

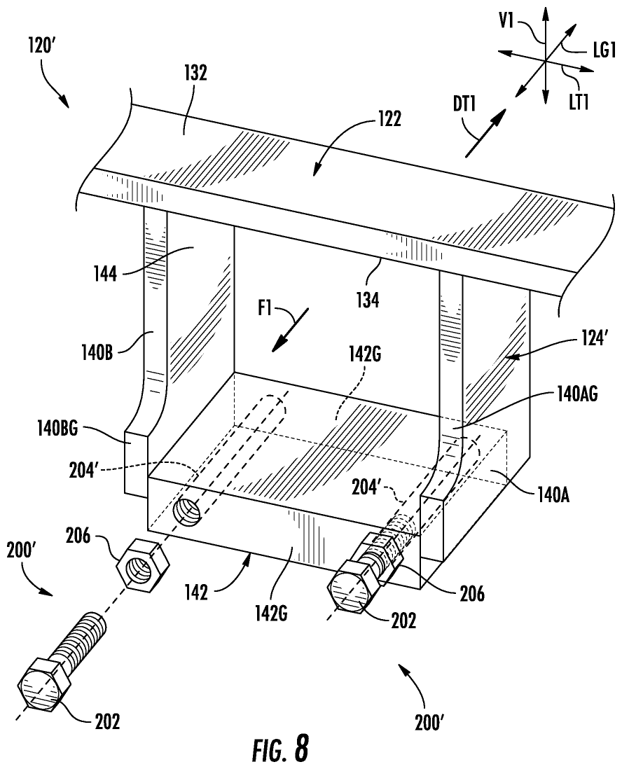

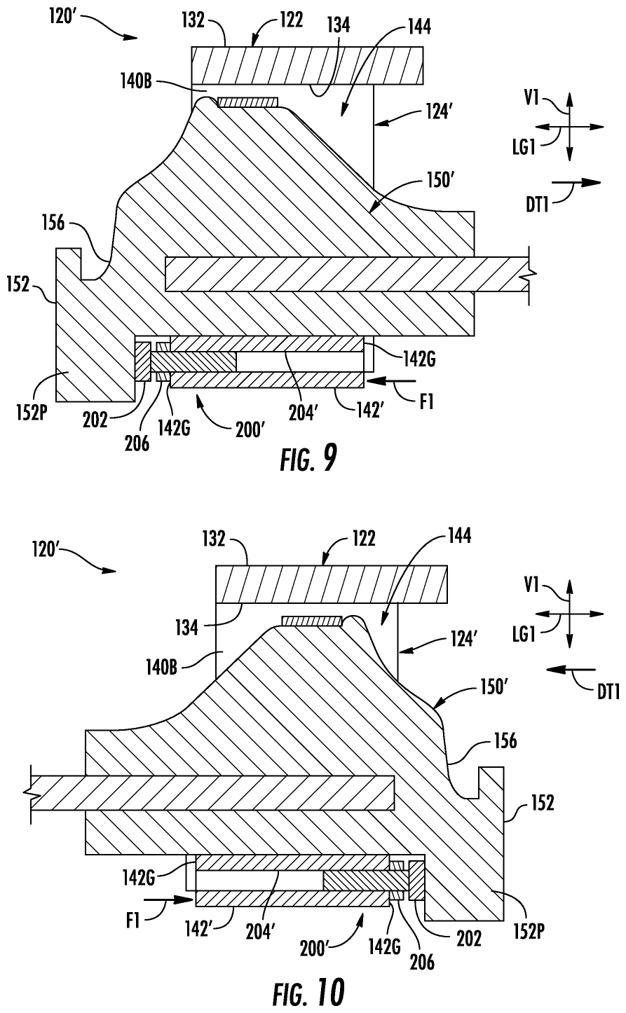

In one embodiment, instead of the adjustable stop assemblies 200 being part of the drawbar 150′, one or more adjustable stop assemblies 200′ may instead be part of a hanger 120′. For instance, referring now to FIGS. 8-10, differing views of another embodiment of a drawbar hanger 120′ for use with the drawbar support assembly 100 is illustrated, where the drawbar hanger 120′ shown in FIGS. 8-10 is substantially the same as the drawbar hanger 120 shown in FIGS. 2-4 and 6-7, except that the hanger 120′ in FIGS. 8-10 is additionally configured with adjustable stop assemblies 200′ for contacting the drawbar 150′. Particularly, FIG. 8 illustrates a partial, perspective view of the hanger 120′ having adjustable stop assemblies 200′, FIG. 9 illustrates a section view of the assembly 100 having the hanger 120′ shown in FIG. 8 with the hanger 120′ being oriented for the intermediate or rearmost support position, and FIG. 10 illustrates another section view of the assembly 100 having the hanger 120′ shown in FIG. 8 with the hanger being oriented for the closest support position.

Each of the adjustable stop assemblies 200′ is substantially the same as the adjustable stop assemblies 200 described above with reference to FIGS. 6 and 7, except that the slot(s) 204′ of the assemblies 200′ are defined within the hanger 120′ instead of being defined within the drawbar 150′. For instance, as shown in FIGS. 8-10, the slot(s) 204′ are defined within the third saddle wall 142′ of the saddle portion 124′ of the hanger 120′. The slot(s) 204′ may extend substantially along and parallel to the longitudinal direction LG1. The slot(s) 204′ are generally configured to allow the stop member(s) 202 received therein to contact the extension portion(s) 152P of the drawbar 150′ (FIGS. 9 and 10) regardless of whether the hanger 120′ is oriented for the intermediate or rearmost support positions (FIG. 9) or the closest support position (FIG. 10). For instance, in one embodiment, the slot(s) 204′ extend through the entire width of the third saddle wall 142′ of the hanger 120′ in the longitudinal direction LG1. As such, the stop member(s) 202 may be insertable into either end of the slot(s) 204′ at the longitudinal end surfaces 142G of the third saddle wall 142′, with the stop member(s) 202 being inserted at least into the longitudinal end surface 142G that will be closer to the extension portion(s) 152P of the drawbar 150′ (FIGS. 9 and 10) to prevent torque of the hanger 120′. However, it should be appreciated that, in other embodiments, separate slot(s) 204′ may be provided that extend only partially through the width of the third saddle wall 142′ of the hanger 120′ in the longitudinal direction LG1, where some of the partial slot(s) 204′ (not shown) may be provided that open to one of the longitudinal end surfaces 142G of the third saddle wall 142′ while others of the partial slot(s) 204′ (not shown) may be provided that open to the other of the longitudinal end surfaces 142G of the third saddle wall 142′.

Regardless of the configuration of the slot(s) 204′, the position of each of the stop members 202 within the respective slot 204′ is variable such that the stop member(s) 202 may be brought into contact with the extension portion(s) 152P of the drawbar 150′ when the drawbar 150′ is received within the hanger 120′ (FIGS. 9 and 10). For instance, the slot(s) 204′ and the stop member(s) 202 may be compatibly threaded, such that the length of the stop member(s) 202 protruding from the slot(s) 204′ may be adjusted by rotating the stop member(s) 202. In some embodiments, each of the adjustable stop assemblies 200′ may also include a locking fastener 206 between at least a portion of the stop member(s) 202 and the slot(s) 204′ to prevent the stop member(s) 202 from rotating due to vibrations during operation of the work vehicle 10.

The hanger 120′ may have any suitable number of adjustable stop assemblies 200. For instance, in some embodiments, the hanger 120′ includes two adjustable stop assemblies 200 spaced apart along the lateral direction LT1 such that the adjustable stop assemblies 200 are at least approximately equidistant from a longitudinal central axis of the hanger 120′ so that the stop assemblies 200 do not create a torque force that causes the hanger 120′ to additionally twist left or right. However, the hanger 120′ may include any other suitable number of adjustable stop assemblies 200. For instance, the hanger 120′ may instead include only one stop assembly 200, or three or more stop assemblies 200.

Similar to the stop assemblies 200, the force F1 applied to the drawbar hanger 120′ by the ground when the drawbar hanger 120′ hits the ground or by an implement via a safety chain when the implement uncouples from the drawbar 150′ while the work vehicle 10 is traveling in the forward direction of travel DT1 is transferred from the drawbar hanger 120′ to the drawbar 150′ via the adjustable stop assemblies 200′. As such, the drawbar hanger 120′ is prevented from torque-related damage derived from ground contact or implement drag forces. It should further be appreciated that, because the position of the stop members 202 of the stop assemblies 200′ is adjustable, the drawbar hanger 120′ and the drawbar 150′ may be in contact, or closer to contact, with each other before a ground impact or implement drag forces regardless of differences in manufacturing or assembly tolerances, which further reduces the potential for damage to the drawbar hanger 120′.

It should be appreciated that the extension portion(s) 152P of the drawbar 150′ used alone, without the stop member(s) 202, may also provide some protection against torque of the drawbar hanger 120, 120′ as the extension portion(s) 152P may limit how far the drawbar hanger 120, 120′ may torque rearward and upward before transmitting at least some of the force F1 to the drawbar 150′. Additionally, it should be appreciated that due to the reduced torque on the drawbar hanger 120, 120′ when the extension portion(s) 152P and/or the stop assemblies 200, 200′ are used, the drawbar hanger 120, 120′ may not require the gusset members 148 (FIG. 8 shows one example of the drawbar hanger 120′ without gusset members) and/or may be made with thinner and/or lighter materials than without the stop assemblies 200, 200′.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for adjustably supporting a drawbar of an agricultural vehicle, the agricultural system comprising:
a rear frame of the agricultural vehicle;
a support member fixed relative to the rear frame, the support member comprising a first support flange and a second support flange spaced apart from each other in a lateral direction, each of the first and second support flanges extending between a first longitudinal end and a second longitudinal end along a longitudinal direction of the agricultural vehicle and defining flange holes spaced apart from each other along the longitudinal direction;
a drawbar hanger comprising a bar support portion and a saddle portion, the bar support portion extending between a first lateral end and a second lateral end along the lateral direction, the bar support portion defining a first bar support hole positioned proximate the first lateral end and a second bar support hole positioned proximate the second lateral end, the first bar support hole being spaced apart from the second bar support hole in the lateral direction, the saddle portion being fixed to the bar support portion such that an opening is formed along the longitudinal direction between the saddle portion and the bar support portion; and
a drawbar extending between a proximal end and a distal end along the longitudinal direction, the proximal end being receivable in the opening formed between the saddle portion and the bar support portion, and the distal end being couplable to the rear frame,
wherein the drawbar hanger is selectively positionable relative to the first and second support flanges along the longitudinal direction such that the first and second bar support holes are aligned with respective ones of the flange holes of the first and second support flanges.

2. The agricultural system of claim 1, wherein the first lateral end of the bar support portion at least partially overlaps the first support flange, and the second lateral end of the bar support portion at least partially overlaps the second support flange.

3. The agricultural system of claim 1, further comprising one or more gusset members, each of the one or more gusset members extending between the saddle portion and the bar support portion.

4. The agricultural system of claim 3, wherein the one or more gusset members is configured to receive the saddle portion of the drawbar hanger.

5. The agricultural system of claim 1, wherein the proximal end of the drawbar has an extension portion that at least partially overlaps a longitudinal end surface of the saddle portion in both the lateral direction and a vertical direction.

6. The agricultural system of claim 5, further comprising an adjustable stop receivable within a slot defined within one of the extension portion or the saddle portion, the adjustable stop being selectively movable within the slot into contact with the other of the extension portion or the saddle portion.

7. The agricultural system of claim 1, wherein the saddle portion has a u-shaped cross-section viewed along the longitudinal direction.

8. The agricultural system of claim 1, further comprising:
at least one first coupling element insertable through the first bar support hole and the respective one of the flange holes of the first support flange; and
at least one second coupling element insertable through the second bar support hole and the respective one of the flange holes of the second support flange.

9. The agricultural system of claim 1, wherein the distal end of the drawbar defines a plurality of openings spaced apart along the longitudinal direction, wherein each of the plurality of openings defined at the distal end of the drawbar is selectively couplable to the rear frame.

10. The agricultural system of claim 1, wherein the drawbar hanger is selectively positionable relative to the first and second support flanges at a first longitudinal position along the longitudinal direction or at a second longitudinal position along the longitudinal direction, the first longitudinal position being closer to the rear frame along the longitudinal direction than the second longitudinal position.

11. The agricultural system of claim 10, wherein the first and second bar support holes are aligned with a first pair of flange holes of the first and second support flanges when the drawbar hanger is disposed at the first longitudinal position and the first and second bar support holes are aligned with a separate, second pair of flange holes of the first and second support flanges when the drawbar hanger is disposed at the second longitudinal position.

12. A drawbar support assembly for adjustably supporting a drawbar of an agricultural vehicle, the drawbar support assembly comprising:
a support member fixable relative to a rear frame of the agricultural vehicle, the support member comprising a first support flange and a second support flange spaced apart from each other in a lateral direction, each of the first and second support flanges extending between a first longitudinal end and a second longitudinal end along a longitudinal direction of the agricultural vehicle and defining flange holes spaced apart from each other along the longitudinal direction;
a drawbar hanger comprising a bar support portion and a saddle portion, the bar support portion extending between a first lateral end and a second lateral end along the lateral direction, the bar support portion defining a first bar support hole positioned proximate the first lateral end and a second bar support hole positioned proximate the second lateral end, the first bar support hole being spaced apart from the second bar support hole in the lateral direction, the saddle portion being fixed to the bar support portion such that an opening along the longitudinal direction is formed between the saddle portion and the bar support portion for receiving a drawbar of the agricultural vehicle;
at least one first coupling element insertable through the first bar support hole and one of the flange holes of the first support flange; and
at least one second coupling element insertable through the second bar support hole and one of the flange holes of the second support flange,
wherein the drawbar hanger is selectively positionable relative to the first and second support flanges along the longitudinal direction such that the first and second bar support holes are aligned with respective ones of the flange holes of the first and second support flanges.

13. The drawbar support assembly of claim 12, wherein the first lateral end of the bar support portion at least partially overlaps the first support flange, and the second lateral end of the bar support portion at least partially overlaps the second support flange.

14. The drawbar support assembly of claim 12, further comprising one or more gusset members, each of the one or more gusset members extending between the saddle portion and the bar support portion.

15. The drawbar support assembly of claim 14, wherein the one or more gusset members is configured to receive the saddle portion of the drawbar hanger.

16. The drawbar support assembly of claim 12, wherein an axis of each of the flange holes, the first bar support hole, and the second bar support hole extends in a vertical direction.

17. The drawbar support assembly of claim 12, further comprising an adjustable stop receivable within a slot defined within the saddle portion, the slot extending along the longitudinal direction, the adjustable stop being selectively movable within the slot into contact with a drawbar.

18. The drawbar support assembly of claim 12, wherein the saddle portion has a u-shaped cross-section viewed along the longitudinal direction.

19. The drawbar support assembly of claim 12, wherein the drawbar hanger is selectively positionable relative to the first and second support flanges at a first longitudinal position along the longitudinal direction or at a second longitudinal position along the longitudinal direction, the first longitudinal position being closer to the second longitudinal end of the first and second support flanges than the second longitudinal position.

20. The drawbar support assembly of claim 19, wherein the first and second bar support holes are aligned with a first pair of flange holes of the first and second support flanges when the drawbar hanger is disposed at the first longitudinal position and the first and second bar support holes are aligned with a separate, second pair of flange holes of the first and second support flanges when the drawbar hanger is disposed at the second longitudinal position.
